(19) United States
(12) Patent Application Publication
(10) Pub. No.: US 2001/0035000 A1
(43) Pub. Date: Nov. 1, 2001

(54) Seagrass plow and method

(76) Inventors: J. Nicholas Ehringer, Seffner, FL (US); Matthew Palascak, Largo, FL (US)

Correspondence Address: Gerard H. Bencen, Bencen & Van Dyke, P.A., 1630 Hillcrest Street, Orlando, FL, 32803, US

(21) Appl. No.: 09/800,275

(22) Filed: Mar. 6, 2001

Related U.S. Application Data
(60) Provisional application No. 60/188,288, filed on Mar. 8, 2000.

(51) Int. Cl. A01D 44/00

(52) U.S. Cl. 56/8; 37/341

(57) ABSTRACT

An underwater plow designed for the efficient removal of seagrass species from one site and transplantation into a new site, and a method of its use is disclosed. The seagrass plow comprises a durable plow with a harvesting blade positioned such that as the plow is drawn along a seabed, samples of seagrass with root systems intact are efficiently harvested for transplantation into an area devoid of seagrass. The method comprises the provision of a seagrass plow, translation of the plow across a seabed location rich in seagrass, such that sections of seagrass are harvested onto a removable tray, removal of the tray from the water with a sample intact, transport of the tray contents to a new location for transplantation of the seagrass, and repeating of these steps. The current invention provides a device and method for the efficient transfer of a protected marine species into a new area which requires substantially less time than traditional methods while providing a greater chance for successful transplantations.

### FIELD OF THE INVENTION

This invention relates to underwater plows and methods of their use, and more particularly to an underwater plow used to harvest marine or aquatic grasses from inshore grass bed, and methods for its use.

### BACKGROUND OF THE INVENTION

Seagrasses are flowering plants that live submerged in coastal environments. They play critical roles in the overall health of the marine ecosystem. These plants form grassy beds that function as nursery grounds for much of the world's recreationally and commercially important marine life. In addition, through the use of rhizomes (root-like structures) that are buried just beneath the sandy bottom, these plants form an elaborate underground matrix that helps to stabilize the near-shore waters. Although seagrasses are not a direct source of food for humans, many of the organisms that depend on these grassy beds for protection, food or as a depository for eggs, are a source of food for humans. Thus, damage to seagrass beds indirectly impacts human use and exploitation of marine resources. As a direct result of human intervention such as, for example, coastal development, pollutant discharge, oil spills, or scarring by boats, seagrass beds worldwide have continued to decline. Recognizing the critical role seagrasses play in the marine environment, many state and national agencies have begun to take protective measures to ensure the survival of many of these threatened or endangered species. As such, a great deal of research has been directed at maintaining existing seagrass beds, and at re-establishing seagrass beds, through transplantation, in areas previously damaged or destroyed by human activity.

Traditional methods for transplanting seagrasses involve hand-held devices that either punch holes in the sediment or scoop them out with a shovel or hoe. No mechanical devices have yet been devised that can remove seagrasses with the root system intact in sections as large as 2 square feet. Backhoes have been used, but they are too large and heavy to use in shallow bays or estuaries. Some projects today require the transplanting of several acres of seagrasses in a very short time frame. In order to remove acres of seagrasses by hand, it would take dozens of employees several months to perform the task. The seagrass plow, although it only removes 2 square feet at one time, offers a safe method of removing seagrasses more quickly. Four or five workers can safely transplant an acre of seagrasses in about one month. With older methods it could take 20 employees about 3 months to perform the same transplant.

The present invention provides a device and method for transplanting sections of existing seagrass beds to another location. In order to move (transplant) seagrasses from one place to another, great care must be taken to not only remove the seagrasses, but also the root system (rhizomes). The seagrass plow is a device that removes the seagrasses without destroying the root system and therefore provides greater opportunity for transplanted beds to be re-established in a new area, and flourish.

### BRIEF DESCRIPTION OF THE DRAWINGS

FIG. 1 provides a schematic of several views of one embodiment of the seagrass plow of this invention, including a top view, a front view, a side view and a view of one embodiment of a box that is placed into the plow for harvesting and transplantation of seagrass.

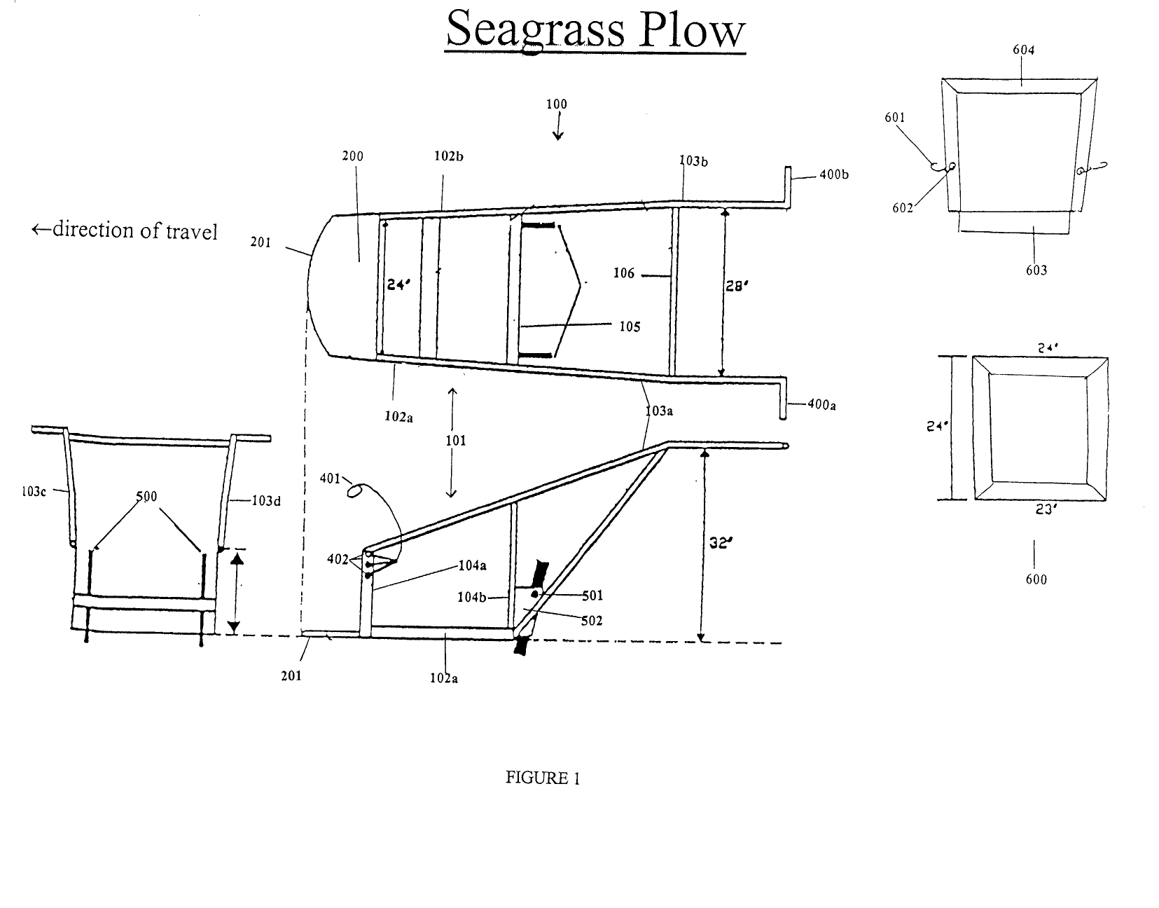

FIG. 2 provides a view of one embodiment of the seagrass plow with the tray removed.

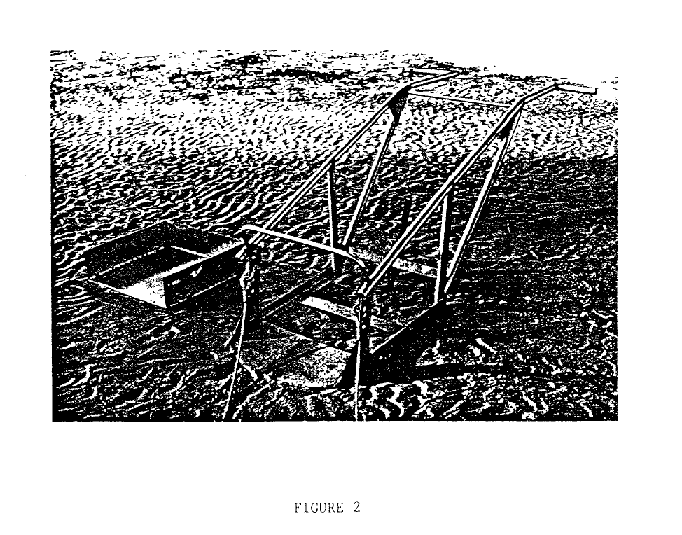

FIG. 3 provides a view of one embodiment of the seagrass plow with the tray inserted.

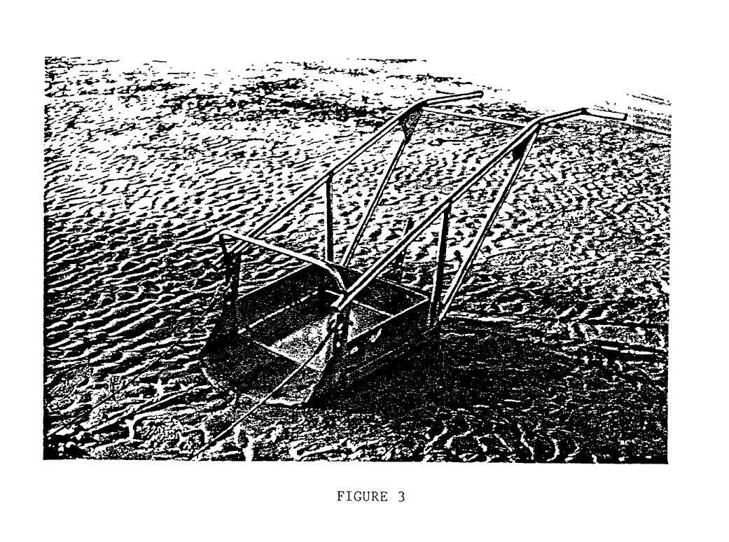

FIG. 4 provides a further view of one embodiment of the seagrass plow with the tray inserted.

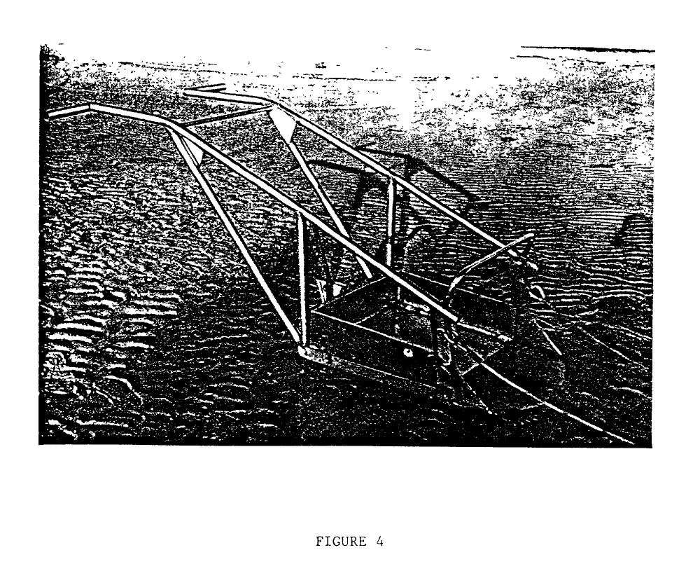

FIG. 5 provides a further view of one embodiment of the seagrass plow with the tray removed.

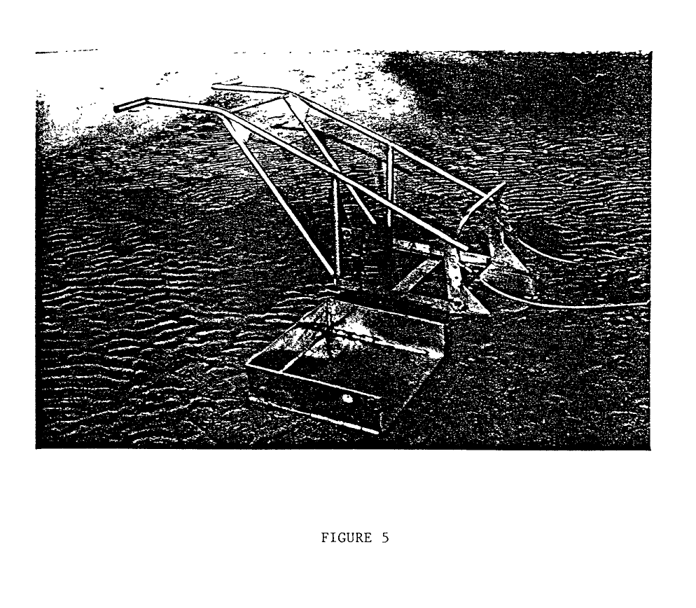

### SUMMARY OF THE INVENTION

The invention is a device and method for efficient harvesting of seagrasses for transplantation to a new site. In its broadest form the device comprises a durable plow with a harvesting blade positioned such that as the plow is drawn along the seabed, sea grass, alone with root structure, is efficiently harvested in transplantable sections. The method comprises the provision of a seagrass plow, translation of the plow across the seabed in a location rich in seagrass such that sections of seagrass and associated root system are harvested onto a tray, removal of the tray to a new location for transplantation of the seagrass, and repeating of these steps. Because the device is able to remove a large, three-dimensional section of a seabed, it has multiple other marine and non-marine related uses that are described herein.

Accordingly, it is one object of this invention to provide a device for efficient harvest and transplantation of sea grass.

Another object of this invention is to provide a method for efficient harvest and transplantation of seagrass.

Another object of this invention is to provide a method for establishing nursery grounds for marine organisms.

Another object of this invention is to provide a method for assessing the degree of soil contamination on shallow water environments resulting from oil spills.

Another object of this invention is to provide a method to assess sediment floral composition in near-shore eutrophic areas.

Another object of this invention is to provide a method to assess sediment micro-fauna composition in near-shore areas exposed to effluent discharge.

Further objects and advantages of this invention will become apparent from the complete disclosure and the claims appended hereto.

### DETAILED DESCRIPTION OF THE PREFERRED EMBODIMENTS OF THE INVENTION AND ITS BEST MODE

The use of the term seagrass is meant to include shoal grass (Halodule wrightii) turtlegrass (Thalassia testudinum), manatee-grass (Syringodium filiforme), small turtle-grass (Halophila baillonis) or similar grasses found in near-shore environments. By near-shore environment is meant that area of the coastal zone containing seagrass beds, ranging from the average high water mark to a distance seaward accessible, without complete submergence of an operator, at average low tide. Use of the term flora is meant to include those plants, algae, or bacteria living on or attached to the soil surface in near-shore environments. Use of the term micro-fauna is meant to include those animals living in, on, or attached to the sediment of near-shore environments. Use of the phrase effluent discharge is meant to include any run-off, spillage, dumping, release, or other entrance of toxic materials or dangerous chemicals into a near-shore environment. Use of the phrase eutrophication event is meant to include any human derived enrichment of near-shore water environments by nutrients, herbicides, pesticides or other chemicals capable of stimulating an array of symptomatic changes including algae blooms, decreased oxygen level (anoxia), increased production of higher plants, macro-fauna die offs, or other events which ultimately decrease the diversity of a biological system.

Reference is now made to the drawings, which show one embodiment of a seagrass plow generally indicated at 100 for travel along a path determined according to the natural contours of a seagrass bed, but generally in a forward direction as depicted by the arrow. The frame 101 includes two laterally spaced lower side frame members 102a and 102b each extending generally along the path of travel, and four laterally spaced upper side frame members 103a, 103b, 103c, and 103d each also extending generally along the path of travel, but angled away from horizontal such that the front end of the device is angled toward the ground and the back end of the device is angled away from the ground. Two upper side frame members 103a and 103b are spaced above their associated lower side frame members 102a and 102b and are joined thereto by front and rear perpendicular side struts 104a and 104b respectively. Other upper side frame members 103c and 103d, are joined together by an intermediate horizontal cross strut 105, and a rear horizontal cross strut 106. All the frame members and struts are formed from steel tubing welded together, or alternatively from other materials that can be molded into a box-like frame which is very strong and relatively light in weight.

The sea grass plow 100 has a sharpened front edge 200 that slides beneath the sea grasses to separate the sediment around the sea grasses from the sediment below. The front edge 200 has a flat laterally extending undercutting blade 201 having a sharpened front edge convexly shaped to make a cut into sediment more precise and effortless. The front edge 200 and blade 201 are affixed to a rigid support structure 104a. The device is propelled forward by pushing on handles 400a and 400b. Each handle 400a and 400b is welded or otherwise affixed to the upper side frame members 103a and 103b generally in a position horizontal and perpendicular to the direction of travel. Alternatively the device is pulled forward by attaching one end of a cable 401 to front holes 402 of the front support strut 104a and the other end of the cable to a propulsion means (not shown). The plow may be pulled in a generally forward direction by a winch and cable device, a motorized vessel, a submarine tractor, or other device capable of generating enough force to pull the machine through soil. Alternatively, a winch and cable set-up is employed such that one end of the cable is affixed to a distant object and the other end is affixed to a winch located on the body frame 101 with a user operable switch mounted on either side of the two handles 400a and 400b. In use, an operator stands behind the plow 100 holding onto handles 400a and 400b that guide the direction of the seagrass plow 100. The handles 400 can be raised to tilt the blade 201 of the plow 100 into deeper sediment or lowered to cut a more shallow section of sediment/seagrass. The operator can steer the plow left or right, up or down.

The depth of cut and forward movement is regulated by one or more skids 500. At the back of the plow a skid 500 extends down into the sediment. The skid 500 may be adjusted from 1 inch to 10 inches into the sediment. Adjustments are made via holes 501 in the connecting plates 502 on both sides of the skids. Bolts or studs (not shown) are placed in the holes 501 to secure the skid 500. The skid 500 creates a drag in the sediment that helps prevent the tilting of the plow forward into the sediment. There may be one or two skids 500 on a plow. If there is one, it is placed in the center. If there are two, they are preferably located on either side and to the rear of the tray holder. Once the separation of sediment/sea grass from other soil is made, the sample components slide onto a removable tray 600 to be lifted from the water. The tray 600 has hooks 601 affixed to holes 602 such that the entire tray may be hoisted to the surface by attaching a winch or similar device to the hooks 601. The tray 600 can have a variable size. For example, it can be 2 feet by 2 feet, or 1 foot by 4 feet. The walls of the tray 600 may also be variable, from 4 inches to 12 inches. The front wall 603 of the tray 600 is removed. This side sits toward the blade 201 so the sediment/sea grass section slides into the tray 600 abutting the remaining three walls. The front wall 603 can be set back into the tray 600 for transport. The dimensions of the tray are not a perfect square. The rear wall 604 of the removable tray 600 is wider than the front wall 603 to prevent a bunching effect as the seagrasses slide into the tray. The rear wall 604 of the tray must generally be at least about one inch wider than the front wall 603. Once the tray 600 is transferred to the planting site, the front wall 603 is removed and the sea grasses, with sediment attached, slide out of the tray 600 onto the floor of the bay.

The sea grass plow 100 is constructed from stainless steel, iron, combinations thereof, or other metals of sufficient strength to sustain the load of being drawn through the seabed for harvesting of seagrass. Preferably, the metal is not subject to corrosion or rust, and preferably, the structural components are welded together. Naturally, cables may need to be attached and detached from the plow, and the height of the skids needs to be adjustable.

In one embodiment of the present invention, seagrass samples are extracted from healthy near-shore seagrass beds and are transplanted into a damaged or destroyed area according to the above described method to foster growth and development of new marine habitats such as, for example, a nursery for juvenile marine species. In one example, the seagrass plow is placed over a seabed rich in seagrass species, the plow is tipped such that the blade penetrates the soil to a depth just below the rhizome root system. The device is attached to a propulsion means such as, for example, a cable attached to boat, to pull the device in a generally forward direction across a seagrass bed such that sections of seagrass and associated root systems are harvested onto a tray. The tray is then hoisted to the surface as previously described, the samples are packed for transportation to a new site, and later implanted at a site substantially devoid of seagrass beds.

In another embodiment the seagrass plow is utilized to collect soil samples used to assess local eutrophication (i.e. excessive growth of aquatic plants such as algae and aquatic weeds), which is normally associated with fouling of beaches and the death of sea grass beds. Through the use of basic transecting techniques known in the field, a researcher can use the seagrass plow to selectively retrieve representative samples from an area. In one example, a soil sample is harvested according to the method previously described. A transect line is laid out across the area to be surveyed and a quadrat is placed on the first marked point on a line. The population of plants inside the quadrat is then estimated based on percent cover. Cover is defined as the area of the quadrat occupied by the above ground parts of a species when viewed from above. Individual flora species present in the sample are then isolated and identified either micro-or macroscopically, and enumerated. By this method, species of marine flora known to thrive in polluted waters are identified and used to assess the relative cleanliness and health of a marine system. This data is then available as predictive indicia of the likelihood that a given area will experience a harmful event linked to eutrophication (i.e. rotting vegetation, fish kills, blooms of toxic algae, anoxia, production of hydrogen sulphide), or conversely the data may be used as a retrospective means to correlate a eutrophic event with a suspected marine source.

In another embodiment, the micro-faunal populations of an area impacted by effluent discharge may be assessed. Through use of basic transecting methods known in the field, representative soil samples are collected from selected near-shore areas, and analyzed for micro-faunal composition. In one procedure, for example, a sediment sample is collected from a transected site according to the method previously described, run through a series of screens to dissociate the soil material from the organisms present therein, processed through serial filtration techniques known in the field, and microscopically analyzed for micro-fauna composition. Individual fauna are identified and population estimates are made for comparison with other samples. Since micro-fauna comprise a critical trophic link in any marine system, use of this method to isolate, identify and enumerate species present in contaminated soil provides valuable insight into the effects of, for example, discharge of pollutants, on the overall health of the environment.

In another embodiment of the present invention, sediment contamination on near-shore environment resulting from, for example, an oil spill, can be assessed. Petroleum, hydrocarbons, heavy metals and other toxicants often accumulate in the surface soil near shore following an oil spill. When exposed to weathering and wave action some types of oil will change chemical composition, become partly hydrophilic, and settle on the ocean floor. The seagrass plow is used to collect a sample of contaminated sediment from an area according to the method previously described. Because the sample remains intact, a quick, accurate visual assessment is made of the depth of oil penetration into the sediment. Knowledge of how deeply oil has penetrated the sediment allows scientists to evaluate the effects of an oil spill on a near-shore environment. Additionally, such information can be used to develop appropriate ameliorative strategies (e.g. releasing oil consuming bacteria into the environment) directed at mitigating long-term effects of oil remaining in the environment.

While the present disclosure and the attached figures provide specific embodiments of the seagrass plow and method for its use, those skilled in the art will appreciate from this disclosure that variations, modifications and equivalents of the specific device elements and method suggested by the present disclosure come within the scope of this invention. Different materials of construction, dimensions for various elements of the device and steps in the method come within the scope of this invention. Thus, for example, construction of the plow from a high-strength polymeric material should be considered as coming within the scope of this invention, provided that construction of the plow from such a material results in acceptable harvest efficiency and durability. Likewise, variations and modifications in the structure, shape or orientation of the harvesting blade, handles, supports, skid(s) and other components may be envisioned. Furthermore, it is conceivable that a self-propelled embodiment of the seagrass plow could be produced by use of appropriate propulsion means. Additionally, other uses requiring the removal of sediment from an area other than a marine environment, such as for example, shallow excavations requiring intact three-dimensional sediment samples, or removal of aquatic grass samples, would be within the scope of this invention. Accordingly, the scope of this invention should not be construed as being limited to the specifics of the detailed disclosure and best mode disclosed herein.

What is claimed is:

1. A durable underwater plow for efficient harvesting of seagrass for transplantation to a new site comprising a plow having a harvesting blade positioned such that as the plow is drawn along a seabed, seagrass is efficiently harvested in transplantable sections.

2. The durable underwater plow of claim 1, wherein said plow provides for the efficient harvesting of seagrass in transplantable sections from seagrass beds, such that the root system of said seagrass remains substantially intact.

3. The durable underwater plow of claim 1, wherein said seagrass is selected from the group comprising: Halodule wrightii, Thalassia testudinum, Syringodium filiforme, Halophila baillonis, and combinations thereof.

4. The durable underwater plow of claim 1, further comprising:
(a) a rigid frame adapted for travel forwardly along a path of travel,
(b) an elongated, laterally extending undercutting blade having a sharpened forward edge,
(c) at least one adjustable skid,
(d) at least one handle for guiding said plow,
(e) attachment means for connection to a propulsion means, and
(f) a removable harvest tray for the collection of seagrass samples.

5. The durable underwater plow of claim 4, wherein said rigid frame is constructed of materials selected from the group consisting of: tubular steel, reinforced aluminum, high-strength polymeric material, or combinations thereof.

6. The durable underwater plow of claim 4, wherein said adjustable skid controls the tilt of said plow as it moves forward along a path.

7. The durable underwater plow of claim 4, wherein said handles may be raised or lowered to angle said blade toward or away from said soil to increase or decrease thickness of seagrass sample cut, or otherwise used to direct said plow along a desired harvest path.

8. The durable underwater plow of claim 4, wherein said propulsion means is selected from the group comprising: a boat, a winch, a winch mounted on a boat, a cable, a chain, a submersible tow, and combinations thereof.

9. The durable underwater plow of claim 4, wherein said seagrass is harvested into a removable tray located behind said blade for transportation to a new site, said tray having attachment means such that the entire tray, including sample, may be hoisted to the surface by attachment to and operation of a lifting device.

10. A method for efficient harvesting of a sample of sediment from seabed locations comprising translating a plow having a harvesting blade across a seabed, such that as the plow is drawn along said seabed, a sediment sample, is efficiently harvested from said seabed into a removable tray, raising said removable tray containing said sediment to the surface such that said sediment sample remains substantially intact, and repeating of these steps.

11. The method of claim 10, whereby establishment of marine nursery grounds comprising seagrass beds is achieved through harvesting sediment containing seagrass, with root system intact, from seabed locations rich in seagrasses, transporting said sediment containing seagrass to a new location substantially devoid of seagrass beds, transplantation of said sediment containing seagrass into said new location, and repeating of these steps.

12. The method of claim 10, wherein said seagrass harvested is selected from the group comprising: Halodule wrightii, Thalassia testudinum, Syringodium filiforme, Halophila baillonis, and combinations thereof.

13. The method of claim 10, whereby the degree of soil contamination on shallow water environments is assessed through harvesting a sediment sample from a desired seabed location, bringing said sample to the surface substantially intact, measuring the depth of contaminant penetration in said sample, and comparing said depth of contaminant penetration to known values or historic records from prior contamination events in similar environments to assess the degree of contamination.

14. The method of claim 10, whereby the eutrophic potential of a marine environment is assessed through harvesting a sediment sample from a seabed location covered with floral species, bringing said sample to the surface, using known transecting techniques to assess composition of floral species in a given area of said sample, identifying said species, and assessing the degree of, or potential for eutrophication of a sampled site using techniques known in the field.

15. The method of claim 10, whereby the health of a marine system exposed to effluent discharge is assessed through harvesting a sediment sample from a seabed location exposed to effluent discharge, brining said sample to the surface, separating sediment material from micro-fauna present by screen and serial filtration techniques known in the field, collecting residue containing micro-fauna, microscopically identifying and enumerating micro-faunal species present in said sediment sample, and comparing data to known compositions of micro-fauna in similar, healthy environments according to techniques known in the field.

16. A durable underwater plow for harvesting seagrass from seabed locations using a plow comprising: a rigid frame adapted for travel forwardly along a path of travel, a harvesting blade for cutting a sample of seagrass from a seabed location; at least one handle for an operator to hold on to for directing the plow along a desired seabed harvest path, at least one adjustable skid for guiding said plow along a seabed harvest path, attachment means for connecting said plow to a propulsion device capable of pulling said plow along a seabed location, and a removable collection tray having attachment means positioned such that the entire tray, including harvested sample, may be hoisted to the surface by a lifting device to transport said seagrass sample to a new marine location devoid of seagrass beds for implantation.
